(19) United States
(12) Patent Application Publication
(10) Pub. No.: US 2011/0307083 A1
(43) Pub. Date: Dec. 15, 2011

(54) System and Method for Physics-Oriented System Configuration

(75) Inventors: Hans-Georg Köpken, Erlangen (DE); Michael Schlereth, Wilhermsdorf (DE)

(73) Assignee: Siemens Product Lifecycle Management Software Inc., Plano, TX (US)

(21) Appl. No.: 12/797,690

(22) Filed: Jun. 10, 2010

(51) Int. Cl. G06F 19/00; G06F 17/50

(52) U.S. Cl. 700/86; 703/6

(57) ABSTRACT

A system, method, and computer readable medium. A method includes maintaining a domain-specific library that includes machine objects for a specific usage domain, and receiving a machine engine model that uses a plurality of machine objects from the domain-specific library. The method includes determining a plurality of object parameters from the machine engine model and generating control code using the plurality of object parameters. The method includes displaying the machine engine model, including the executing the control code.

### CROSS-REFERENCE TO OTHER APPLICATION

This application includes subject matter similar to that of concurrently-filed, commonly assigned U.S. patent application Ser. No. ______ for “System and Method for Machine Engine Modeling”, which is hereby incorporated by reference.

### TECHNICAL FIELD

The present disclosure is directed, in general, to systems and methods for use in computer-aided design, manufacturing, using, modeling, and visualization (individually and collectively, “CAD” and “CAD systems”) and in product lifecycle management (“PLM”) and other systems.

### BACKGROUND OF THE DISCLOSURE

Many manufactured products are first designed and modeled in CAD systems, and PLM systems are used my manufacturers, retailers, customer, and other users to manage the design, use, and disposal of various products. Improved systems are desirable.

### SUMMARY OF THE DISCLOSURE

Various embodiments include systems, methods, and computer readable mediums. One disclosed method includes maintaining a domain-specific library that includes machine objects for a specific usage domain, and receiving a machine engine model that uses a plurality of machine objects from the domain-specific library. The method includes determining a plurality of object parameters from the machine engine model and generating control code using the plurality of object parameters. The method includes displaying the machine engine model, including the executing the control code.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 depicts a block diagram of a system in accordance with disclosed embodiments; and

FIG. 3 depicts a high-level flowchart of a process in accordance with disclosed embodiments.

### DETAILED DESCRIPTION

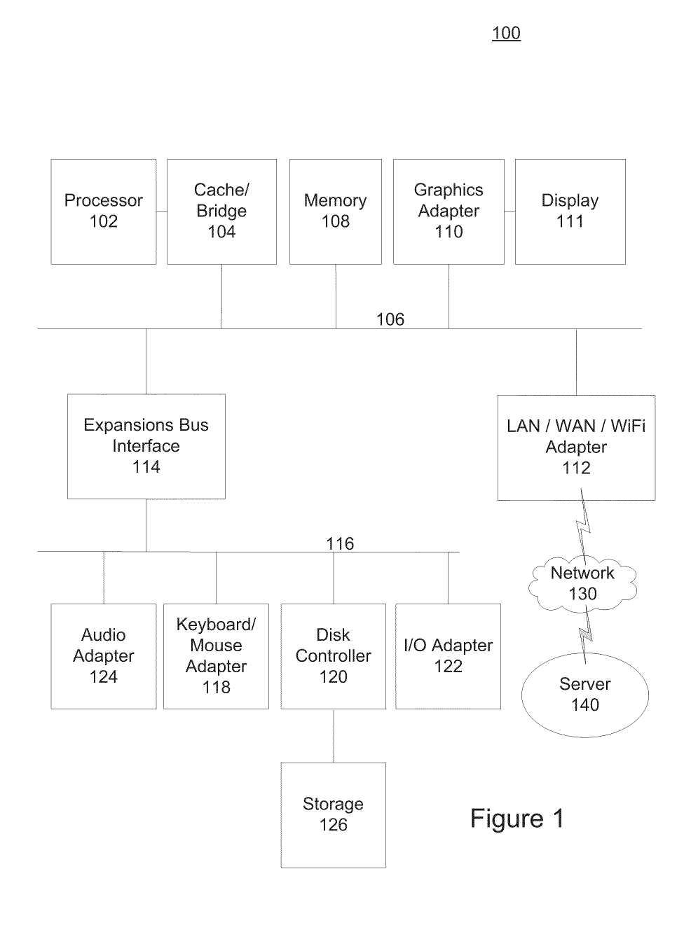

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In the early engineering phases of developing machines and systems processes, the machine concept is generally created in the form of machine sketches or graphically in the form of a CAD or PLM model. When implemented, automation systems must be adapted to the physical conditions of the automation task as well as the installation site. For example, the selection of the correct motor and drive converter for an actual machine/system is a complex task that requires deep understanding of physical relationships and detailed knowledge of the limits of various drives.

In a typical development process, the physical parameters are taken manually from existing descriptions, such as layout plans, text specifications, flow charts, etc. Using the example above for supporting the drive design, the design process might include using a specialized product or database that includes information on all of the limits of the drives. However, in using such a product, the user must manually abstract his application by entering the corresponding number values into the input dialogs for describing the application. This is difficult and prone to errors for many users and represents a significant effort even for experienced users.

Disclosed embodiments include systems and methods for more effective machine engine modeling of physical systems and environments.

FIG. 1 depicts a block diagram of a data processing system in which an embodiment can be implemented, for example when configured to perform processes as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network, or combination of networks, as known to those of skill in the art, including the Internet. Data processing system 100 can communicate over network 130 with server system 140, which is also not part of data processing system 100, but can be implemented, for example, as a separate data processing system 100.

Disclosed embodiments include systems and methods for creation of a machine engine model of physical machines and systems.

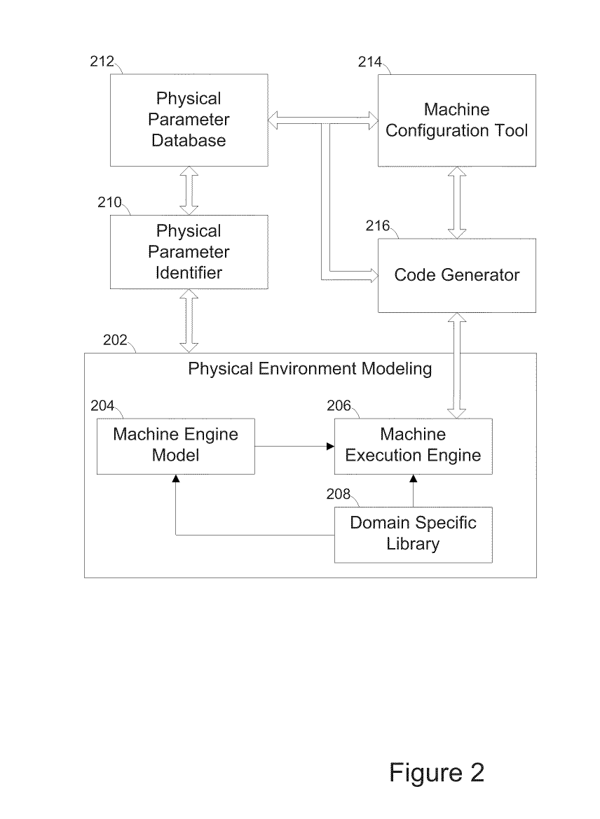

FIG. 2 depicts an example of a system in accordance with disclosed embodiments. The system is built as a simulation that can be created intuitively to represent a virtual environment, and can automatically leverage data describing the parameters and other attributes of the physical devices represented in the simulation. The simulation can be used, for example, to simulate automated machinery or a computer game as a virtual world in which all of the objects behave realistically through a physics-based simulation.

Physical environment modeling 202 includes a machine engine model 204 that is executed by a machine execution engine 206, and both of these interact with a domain specific library 208. A domain specific library, in this context, is a library that includes machine objects and elements, along with any corresponding CAD, PLM, operational, or other data, for a machine in a specific usage domain, including an automation domain, such as automotive, industrial, fluid or cloth handling, or otherwise, and including a physical environment domain that describes the objects a specific simulated physical environment domain and the ways in which they can interact.

The domain specific library 208 includes the properties of an object needed by the machine execution engine 206 to simulate the behavior of these objects. By the separation of object properties, which can be stored in the machine model 204, and the simulation algorithms, which can be implemented in the machine execution engine 206, it is possible to use different machine execution engines on the same machine model. For example, this provides the advantage of enabling different machine execution engines to execute a simulation on different levels of detail, or can enable game engines to operate with different simulation behavior on the same game scene. By using a library that is specific to a domain, the recognition processes described herein, can operate more efficiently. Of course, those of skill in the art will recognize that the defined “domain” can be more or less specific as required for particular implementations.

The machine engine model 204 describes the machine and its automation task, and the machine execution engine 206 displays and simulates the machine and its automation task. Also, or alternately, these can display a “scene” such as a simulated environment including automated machinery environments, simulated physical environments such as in a game or otherwise, or other simulated environment, and this environment can function as the “domain”. In contrast to existing systems, the automation task is not necessarily described in the form of a programming language, but can be described instead in the form of a model built from elements of a domain specific library 208. The data properties of this model can be used by implementations of a machine execution engine 206 that can simulate the automation task or other physical relationships and interactions according the desired analysis aspects, e.g. with respect to stiffness or with respect to kinematic motion. The machine engine model 204 can be, e.g., a full graphical 3D model or a higher-level abstract model in the form of elements or objects as described by the domain specific library 208 and their relationships with each other. Because, in some embodiments, only elements from the domain specific library 208 are used, the system can build a model very quickly and easily, with or without the interaction from a user.

In some embodiments, a machine engine model 204 can be created only within the specified framework of the domain specific library 208. In these cases, additional, alternative, or other elements can be added to the model by the creation of new library elements for domain specific library 208.

In the domain specific library 208, library elements can be represented in various ways, e.g., graphically for the processing of the machine engine model 204, as a search pattern (e.g., with tags) for identification, or as a state machine for execution. In special cases, these representations can be identical, e.g., the graphical shape is used for the simulation as engineering, runtime, and search representations. The library elements are included in the domain specific library 208 for a certain machine type. The parameters of these elements are taken from machine engineering and can deviate from the parameters of a real, constructed machine.

In order that the machine engine model 204 and machine execution engine 206 models the parameters of the corresponding physical systems as realistically as possible, machine runtime data 214, such as the parameter set from a one or more specific physical machines, can be preloaded as part of the machine objects in the domain specific library 208 or as modifications to or parameters of those objects. The machine execution engine 210 needs not to use all detail parameters of the machine model but can, for example, only work on a subset of the parameters for performance reasons if appropriate for the machine analysis.

The machine execution engine 210 receives the created machine engine model 204 and the required objects from the domain specific library 208, such as runtime representations of the library elements being used, and executes the automation task defined by the machine execution model 204. The execution of the automation task here can include, e.g., a simulation of the machine mechanics/machine physics, simulation of a control task for sensors or actuators in the machine engine model 204, and other simulation and visualization tasks.

The machine engine model 204 can be created either manually via an interaction with a user, or automatically by the system, can be received from an other system, or can be loaded from storage. For manual creation, library elements can be selected from the domain specific library 208 and placed into the machine engine model 204, for example, via an interaction with a user. Here, placement can include a geometric placement in the sense of a 3D model or the placement in an abstract machine model, e.g., in a module graph.

For automated creation, machine description data can be used. This can include a machine description or other data created in a legacy tool, such as a CAD program.

The system can take components and complex modules from application-specific libraries such as domain specific library 208 that can be displayed graphically, e.g., as a warehouse, and can combine these into a machine (or system). The modules can already be associated with a behavior, e.g., a conveyor belt runs automatically when an object is placed on it.

The system can simulate and display, in the physical environment modeling 202, virtual controls, sensors, actuators, and other devices to control and interact with the simulated objects. For example, the environment can include a control panel on which the speed of a conveyor can be set with a control button. As another example, a plug for an external photo sensor can be there that can be placed as a separate module and that can be connected to the conveyor in order, e.g., to stop the belt when a jam is behind the belt.

The system can also simulate material sources for generating discrete objects or a continuous material flow that feeds a simulated machine to be dimensioned. In such a case, a slide control on the box can set the speed at which objects/materials are fed. The selection of the cooling type for the drive converter can be performed, e.g., by arranging a switching cabinet with air cooling or with a heat exchanger on the back wall.

As shown in FIG. 2, machine-relevant physical parameters can be determined from the machine engine model 204 in the physical environment modeling 202 by means of physical parameter identifier 210 and are stored in a physical parameter database 212. If, for example, conveyor elements in a simulation were modeled with all of the inclines, curves, and other properties, as well as the expected material, the system can derive different automation-relevant parameters from this modeling:
For the controller: control program, e.g., maximum speeds in curves, run-up/braking curves, and other parameters; and
For the drive design: rule parameters, motor sizes, and other parameters.

For design parameters not available from the physical parameter identifier 210, the user can add virtual probes to identify other relevant parameters, such as a torque curve of a drive shaft and others. These virtual probes can measure also parameters which would be not accessible in the real system, for example due to mounting limitations or hazardous environment.

Other elements, such as, e.g., hydraulic cylinders or pneumatics, can also be modeled. In these cases, parameters such as maximum/minimum piston stroke or necessary air pressure could also be derived from the simulation. The simulation can be performed either with a simplified drive/control model or with virtual controls/drives. The simplified drive model can simulate the drive/motor, e.g., by means of a standard structure or a physical motor model.

In a later design phase, when the development of the control environment has begun, the simulated physical devices and controllers, such as drives or control models, can be more efficiently used for simulation, since relevant parameters have already been derived. In this way, the quality of the design can be improved iteratively.

Non-structural specifications can also be set graphically in the physical environment modeling. For example, the selection of the power-grid voltage can be set, by arranging a power-grid connection box with the label “USA 400V 60 Hz” or otherwise. The results can also be shown in the virtual world of the physical environment modeling; for example, a suitable motor in the correct size can be shown on the conveyor, with other information such as type label and price label. In A switching cabinet, the corresponding drive converters are shown.

As a result of this modeling process, the simulated physical environment, such as a machine or game scene, is created that can then be executed in by the machine execution engine 206, that can also include other functions such as a physics engine.)

The use of these physical parameters is also shown in FIG. 1. With the help of the physical parameters stored in physical parameter database 212, configuration tools, the electrical components (e.g., drives), hydraulic components (e.g., stroke cylinders), mechanical components (e.g., gears), and other components and tools can be designed and parameterized. In general, from this configuration, new physical parameters are created that are stored, in turn, in the physical parameter database 212. Based on these parameters, the machine application or simulation can be executed in the machine execution engine 206 again and, if necessary, tested and corrected.

The automated derivation, identification, and storage of physical parameters from a virtual physical environment, such as a game world, automated machine, and otherwise, provides significant technical advantages in system and simulation design. This process is particularly useful in combination with an automation-specific engineering tool, such as drive design, controller engineering, hydraulic calculation. In addition, the physical parameters and the configuration results for electrical, hydraulic, mechanical, and other components can also be used as a basis for the engineering of the automation program. With the help of virtual controllers and drives, the simulation of the machine application in the machine execution engine 216 can also be refined.

After the system recognizes, extracts, and stores the physical parameters in the physical parameter database 212, these parameters are used by a machine configuration tool 214 to modify the machine configurations that describe the operation of the simulated machines and other objects. A code generator 216 then uses the machine configurations from the machine configuration tool 214, along with parameters from the physical parameter database 212, to generate new or modified control code to be used by the machine execution engine 206. This process can be performed iteratively or continuously so that the physical parameter database 212 is continually updated with parameters derived from the physical environment modeling 202 by physical parameter identifier 210, and these parameters are then used to update the machine configurations and control code used by the machine execution engine 216.

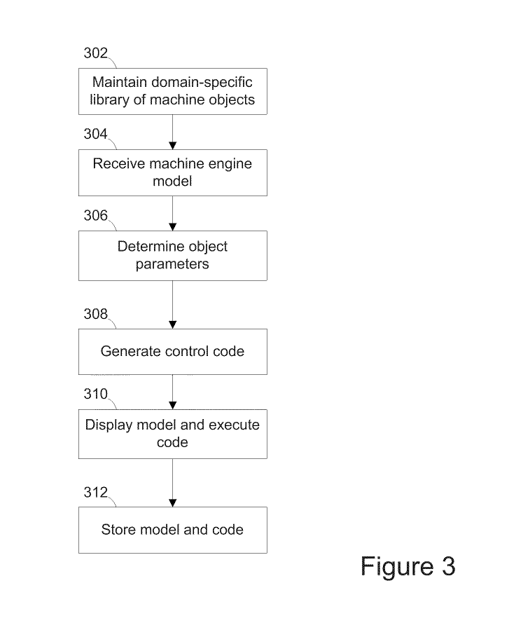

FIG. 3 depicts a flowchart of a process in accordance with disclosed embodiments.

The system maintains a domain-specific library of machine objects and other data that correspond to a specific usage domain (step 302).

The system receives a machine engine model that uses at least some of the machine objects and other data from the domain-specific library (step 304). The machine engine model defines at least one automation task, simulated physical interaction, or other interaction between the machine objects. “Receiving”, as used herein, can include loading from storage, receiving from another data processing system such as over a network, receiving through an interaction with a user, or otherwise. This step can include an interaction with a user to interactively build the model. The machine engine model can simulate an interaction of the physical objects in a computer-generated physical environment. This step can include receiving modifications to the machine engine model.

The system determines a plurality of object parameters from the machine engine model (step 306). These object parameters can describe physical attributes of various objects including size and configuration, materials requirements, and others, can describe non-physical attributes of various objects such as pricing, power or control requirements, operating parameters and others, can describe simulation display information such as sizing, location, and interrelated other objects, and can include other data. The object parameters can be stored in a physical parameter database.

The system generates control code using the plurality of object parameters (step 308). As described herein, this control code allows the system to more accurately display the simulation.

The system displays the machine engine model, including executing the control code (step 310). In this step, the system can show a simulation of the machine engine model and its machine objects. This step can include a simulation of physical interactions according to the machine engine model, for example as an interaction of physical objects in a computer-generated physical environment, or other simulations or animations of the model. This step can include attaching an exchangeable machine execution engine to the machine engine model to perform this execution. In various embodiments, the machine execution engine knows how to simulate machine objects with a property set for a specific kind of simulation or analysis.

The system stores the machine engine model and control code (step 312).

The various steps described above may be performed repeatedly, iteratively, concurrently, or in a different order. In particular, the machine engine model may be modified during of after it is displayed and any simulation run, and the object parameters can be determined, stored, and used to generate new control code for a subsequent or continuing simulation.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method, comprising:
maintaining a domain-specific library in a data processing system, the domain-specific library including machine objects for a specific usage domain;
receiving a machine engine model by the data processing system that uses a plurality of machine objects from the domain-specific library;
determining a plurality of object parameters from the machine engine model by the data processing system;
generating, by the data processing system, control code using the plurality of object parameters; and
displaying the machine engine model, including the executing the control code, by the data processing system.

2. The method of claim 1, wherein the plurality of object parameters are stored in a physical parameter database.

3. The method of claim 1, wherein executing the control code includes a simulation of physical interactions between the machine objects according to the machine engine model.

4. The method of claim 1, wherein the machine engine model simulates an interaction of a plurality of physical objects in a computer-generated physical environment.

5. The method of claim 1, wherein the object parameters include physical attributes of at least one of the plurality of machine objects.

6. The method of claim 1, wherein the object parameters include non-physical attributes of at least one of the plurality of machine objects.

7. The method of claim 1, wherein the machine engine model is received and modified via an interaction with a user.

8. A data processing system comprising a processor and accessible memory, the data processing system particularly configured to perform the steps of:
maintaining a domain-specific library that includes machine objects for a specific usage domain;
receiving a machine engine model that uses a plurality of machine objects from the domain-specific library;
determining a plurality of object parameters from the machine engine model;
generating control code using the plurality of object parameters; and
displaying the machine engine model, including the executing the control code.

9. The data processing system of claim 8, wherein the plurality of object parameters are stored in a physical parameter database.

10. The data processing system of claim 8, wherein executing the control code includes a simulation of physical interactions between the machine objects according to the machine engine model.

11. The data processing system of claim 8, wherein the machine engine model simulates an interaction of a plurality of physical objects in a computer-generated physical environment.

12. The data processing system of claim 8, wherein the object parameters include physical attributes of at least one of the plurality of machine objects.

13. The data processing system of claim 8, wherein the object parameters include non-physical attributes of at least one of the plurality of machine objects.

14. The data processing system of claim 8, wherein the machine engine model is received and modified via an interaction with a user.

15. A computer-readable storage medium encoded with computer-executable instructions that, when executed, cause a data processing system to perform the steps of:
maintaining a domain-specific library that includes machine objects for a specific usage domain;
receiving a machine engine model that uses a plurality of machine objects from the domain-specific library;
determining a plurality of object parameters from the machine engine model;
generating control code using the plurality of object parameters; and
displaying the machine engine model, including the executing the control code.

16. The computer-readable storage medium of claim 15, wherein the plurality of object parameters are stored in a physical parameter database.

17. The computer-readable storage medium of claim 15, wherein executing the control code includes a simulation of physical interactions between the machine objects according to the machine engine model.

18. The computer-readable storage medium of claim 15, wherein the machine engine model simulates an interaction of a plurality of physical objects in a computer-generated physical environment.

19. The computer-readable storage medium of claim 15, wherein the object parameters include physical attributes of at least one of the plurality of machine objects.

20. The computer-readable storage medium of claim 15, wherein the object parameters include non-physical attributes of at least one of the plurality of machine objects.

21. The computer-readable storage medium of claim 15, wherein the machine engine model is received and modified via an interaction with a user.
